(19) United States
(12) Patent Application Publication
(10) Pub. No.: US 2007/0214273 A1
(43) Pub. Date: Sep. 13, 2007

(54) Across firewall communication system and method

(75) Inventors: Mukesh Kacker, Sunnyvale, CA (US); Jasbir Singh, Lafayette, CA (US); Rajagoplan Sundararaghavan, Fremont, CA (US); Ram P. Rustagi, Bangalore (IN)

Correspondence Address: DAVIS WRIGHT TREMAINE, LLP, 1201 Third Avenue, Suite 2200, SEATTLE, WA, 98101-3045, US

(73) Assignee: Pronto Networks, Pleasanton, CA (US)

(21) Appl. No.: 11/372,745

(22) Filed: Mar. 10, 2006

(51) Int. Cl. G06F 15/16; G06F 17/00; G06F 9/00

(52) U.S. Cl. 709/229; 726/11

(57) ABSTRACT

An across firewall communication system and method is used with a conventional firewall positioned between a conventional intranet and an outside network, such as the public Internet. The across firewall communication system provides enhanced communication between one or more inside devices on the intranet and one or more outside devices on the outside network. The across firewall communication system addresses issues commonly raised in today's Internet environment where some devices attempt to communicate with other devices that are isolated behind firewalls and network address translators (NATs).

### BACKGROUND OF THE INVENTION

1. Field of the Invention

The present invention relates generally to network communication, and more particularly to network communication across firewalls.

2. Description of the Related Art

In computer terms, an enterprise is any organization that uses computers. An intranet is generally associated with the enterprise as a private network contained within and used by the enterprise for such things as sharing information and computer resources among enterprise personnel. An intranet may have only one local area network (LAN) or may have many communicatively linked LANs and also have owned or leased lines of a geographically dispersed network as part of an overall wide area network (WAN) backbone of the intranet. With tunneling technologies, portions of an intranet can be linked to each other through an outside network other than the intranet, such as the Internet, with special encryption/decryption and other security safeguards to connect one part of the intranet to another. An intranet could actually have only one computer on the intranet if for example the computer is connected to a small personal LAN hub that is connected to a broadband modem that is used to connect to an outside network such as the Internet. In other examples, a single computer not directly connected to an outside network could be connected directly to a broadband modem or other modem or other connection device that is used to connect to an outside network. For purposes of discussion below, in these and other cases a single computer could also be considered as part of an intranet.

Oftentimes, members of an enterprise that use client computers on the enterprise's intranet use their client computers to access devices and resources, such as server computers, on networks outside their intranet, such as resources found on the public Internet, through firewall servers or other firewalls including firewall devices and network address translators (NATs). Although the firewalls can allow communication across themselves such as allowing enterprise members access to resources on networks outside of their intranet, the firewalls can prevent those computers on outside networks from accessing intranet devices and resources.

To accomplish this gate keeping function, a firewall determines whether to allow communication across itself between an intranet client computer and a resource on an outside network. Determination is made as to whether to forward each candidate network packet that potentially would flow across the firewall from one side of the firewall to the other side of the firewall toward its destination. Factors involved in this determination include such considerations as what intranet client computer requested access and what outside device or resource is to be accessed.

Typically, communication across firewalls use sessions initiated by a client computer on an intranet. The sessions are typically for standard bi-directional network communication between the intranet and a computer resource on a network outside the intranet, such as the Internet. This conventional approach works fine when the intranet client computer is to access an outside resource.

Unfortunately, security issues arise when computers located on outside networks have legitimate requirements to access client computers and other devices and resources on the intranet. In many cases, those outside computers would, if possible, access the intranet client computers or other devices through communication over the Internet and then through the firewall linking the intranet to the outside network such as the Internet. In providing access to an intranet device or resource for an outside computer, conventional approaches create an undesirable security issue by requiring that certain ports be open and state maintenance extensions be implemented in the firewall. Another undesirable security issue created by conventional approaches is that someone other than a member of the enterprise can gain knowledge of the routable address of one or more computer systems on the Enterprise's intranet.

Other problems arise with conventional approaches such as the widespread use of NAT (network address translator) protocols, which detracts from an accepted use of IP addressing to create isolated Internet “islands.” Another problem with conventional approaches involves a common use of firewall chaining, in which access to an intranet is provided through sequentially linked firewalls. The necessity imposed by the conventional approach involving opening of firewall ports and added state maintenance adds undesirable complications to this desired firewall chaining.

Further problems exist with the conventional approaches. For communication to be initiated in the public Internet, the device initiating the communication needs to use a public routable address to the device it is attempting to communicate with. The public routable addresses are often obtained from a naming service (e.g. DNS). The public routable addresses are public and routable from anywhere in the global Internet and issued by IANA (Internet Addressing and Numbering Authority).

The public routable addresses also tend to be relatively static (not change often) and “well known.” Consequently, naming servers (e.g. DNS) can replicate the public routable addresses in the distributed host name of the naming servers to address lookup databases. Furthermore, client computers and other client devices can access the public routable address by their well known names (e.g. DNS domain name) and using the well known port numbers for protocols. The device initiating the communication can be on an intranet behind a firewall device such as a NAT and use a different address space, which is possibly private and non-routable. A NAT typically uses a single public address, although there could be more than one public address used for the Internet side to communicate with Internet accessible devices. However on the intranet side, the NAT typically uses a private address and can support many more devices using a single IP address using a technique known as source NAT. An exemplary conventional network portion 10 is shown in FIGS. 1 and 2 with an inside device 12, such as a client computer, having a non-routable private IP address on an intranet 13 isolated by a firewall 14, such as a firewall device or NAT, from an outside network 15, such as the public Internet. The firewall 14 has a non-routable private IP address on the intranet side of the firewall and a routable public IP address on an outside network side of the firewall. An outside device 16, such as a server, is depicted to be on the outside network/Internet 15 with a routable public static IP address.

A specific port number in the public routable IP address of the firewall 14 corresponds to a private IP address on the intranet side of the firewall. The firewall 14 translates the port number also. Conventional approaches can be ill equipped to provide capability to the outside device 16 to initiate communication with a specific one of the inside devices 12 on the intranet 13 behind the firewall 14 at a specific IP address and port number. The outside device 16 on the outside network side of the firewall 14 has no way to know what address and port number to use as the address assigned for the intranet 13 behind the firewall is unreachable and unknown to the outside device.

Conventional approaches at exposing private addressing to the outside devices 16 on the outside network/Internet 15 involve complicated methods using a one-to-one mapping to many public addresses. Further, any associated functionality of the firewall 14 has to provide an application level gateway to such addresses for specific requests coming from the outside network/Internet side. These conventional approaches deter from reasons for installing NATs and Firewalls in the first place and present much deployment and management headaches for administrators. Some sophisticated connection tracking is available for well-established protocols, but hinders rapid deployment of new protocols as the firewalls and NATs have to be reconfigured.

### BRIEF DESCRIPTION OF THE SEVERAL VIEWS OF THE DRAWING(S)

FIG. 1 is a schematic view of a conventional network portion subject for use of a cross firewall communication system according to the present invention.

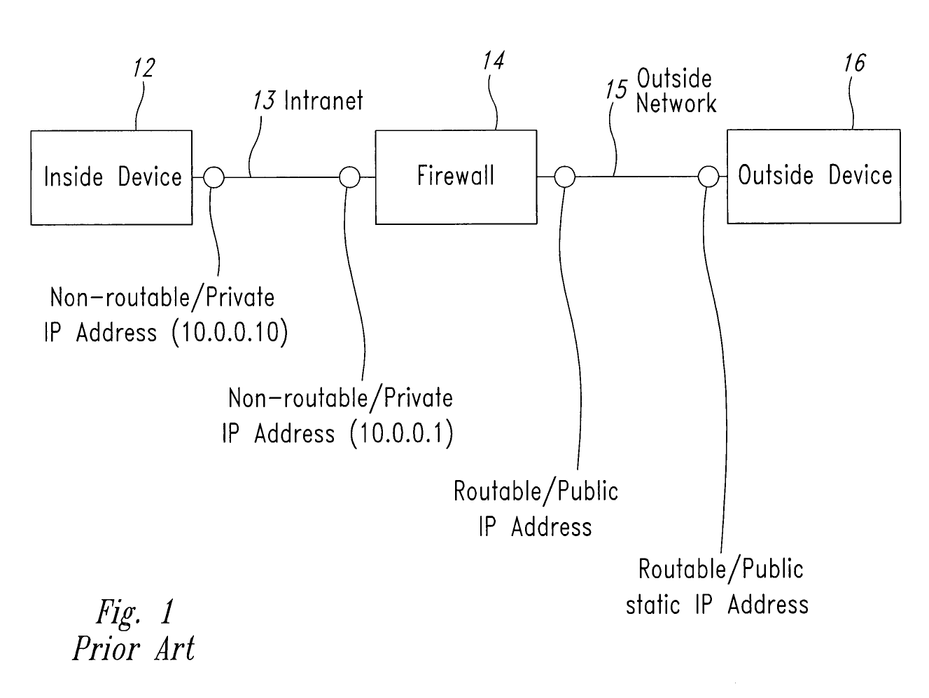

FIG. 2 is an alternative schematic view of a conventional network portion subject for use of the cross firewall communication system.

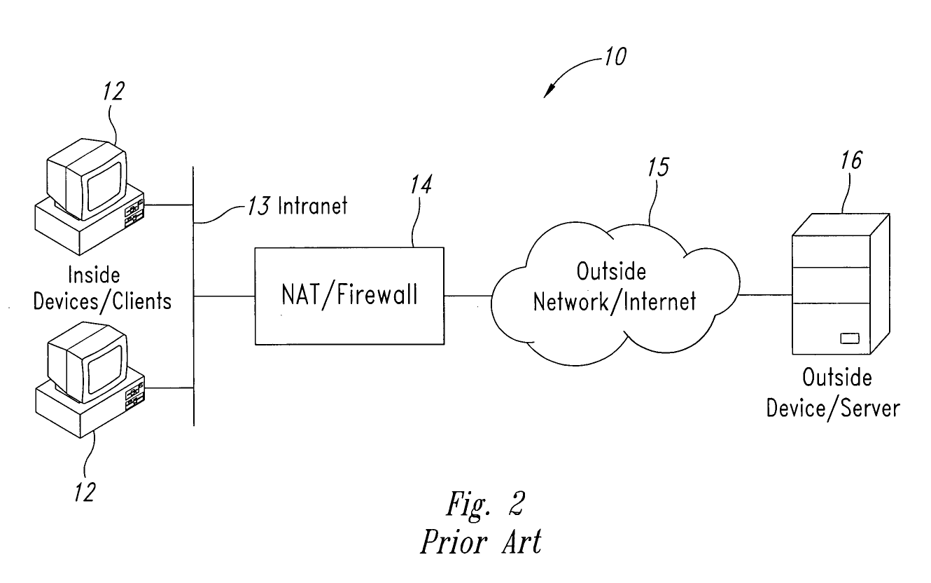

FIG. 3 is a communication diagram depicting representative examples of operation by the cross firewall communication system.

### DETAILED DESCRIPTION OF THE INVENTION

An across firewall communication system and method according to the present invention is used with the conventional firewall 14 positioned between first, the conventional intranet 13 or an isolated computer system and second, the outside network 15 that is separate from the intranet or the isolated computer system, such as the public Internet. The across the firewall communication system provides enhanced communication between first, one or more of the inside devices 12 on the intranet 13 or the isolated computer system and second, one or more outside devices 16 on the outside network 15. The across firewall communication system addresses issues commonly raised in today's Internet environment where some devices attempt to communicate with other devices that are isolated behind firewalls and network address translators (NATs).

Implementations of the across firewall communication system are directed to peer to peer communication that allow for bi-directional session initiation without the security compromises and other configuration changes experienced by firewalls and NATs imposed by conventional approaches. As further discussed below implementations of the across firewall communication system can behave in a manner similar to synchronous communication or in another manner similar to asynchronous communication. Firewall is meant to include all forms of software, hardware, and firmware that embody the general concepts discussed herein with regard to firewalls and NATs and are not limited to particular embodiments of firewalls or NATs.

The across firewall communication system generally includes an inside component located on the inside device 12 on the protected side of the firewall 14, such as on a client computer on the intranet 13. The across firewall communication system further includes an outside component on the outside device 16 on the outside network 15 on the side of the firewall opposite the protected side, such as on a server computer on the Internet.

In other implementations the inside component may be on another type of the inside device 12 such as a server computer on the intranet 13 or may be on a sole server or a sole client computer directly connected to the firewall 14 rather than being linked by the intranet 13 to the firewall. In other implementations, the outside component may be on another type of the outside device 16 such as on a client computer.

In these implementations the inside component and the outside component can be software modules that run on the inside device 12 and the outside device 16, respectively. In other implementations the inside component and/or the outside component can be firmware or hardware that are either part of the inside device 12 and the outside device 16, respectively or are physically separate, but operate in conjunction with the inside device and the outside device, respectively.

The inside component includes an initiator that in some implementations initiates a communication connection with the outside component, such as a peer to peer communication connection between the inside device 12 and the outside device 16. The inside component further includes a heartbeat message portion that sends heartbeat request messages on the communication connection from the inside device 12 to the outside device 16. In some implementations, the heartbeat message portion may be set on a predetermined interval basis to periodically transmit the heartbeat request messages at a predetermined rate. In other implementations, a predetermined interval basis is set so that heartbeat request messages are transmitted by the inside device 12 in a non-periodic fashion bounded by a specified time period such that a heartbeat request message is transmitted at least once in the specified time period. In effect, a predetermined selection is made of a plurality of instances of time to transmit a heartbeat message in which the instances of time are spaced in some fashion such as orderly or even randomly over certain periods of time.

When the outside device 16 receives a heartbeat request message from the inside device 12, the outside component of the outside device transmits a heartbeat response message back to the inside device. At the point in time when the outside device 16 transmits a heartbeat response message, if the outside device has a payload of data, commands, executables, and/or other electronic files to transmit to the inside device 12, and/or the outside device has a request for a payload to be received from the inside device, the payload or request to be delivered to the inside device is carried on the heartbeat response message.

In some implementations, the degree of permanency of an across firewall connection can be user selectable and is supported by the outside device 16, such as a server. In some cases, a user may select having a constant active connection until the connection is ended by user initiation. Regardless of degree of permanency selected, when a connection is not active, either on a periodic or non-periodic basis, the inside component repeatedly initiates and establishes a communication between the inside device 12 and the outside component of the outside device 16. Heartbeat request messages are initiated from the inside device 12 and heartbeat response messages are returned in acknowledgement by the outside device 16. In effect, a predetermined selection is made of a plurality of instances of time to transmit a heartbeat message in which the instances are spaced in some fashion such as orderly or even randomly over certain periods of time.

If the degree of repetition of communication requests is undesirably high there could be excessive network traffic. On the other hand, if the degree of repetition of communication requests is undesirably low there could be excessive delay in the inside device 12 responding to a request by the outside device 16. The amount of communication initiated and established by the inside component in a given time period can be adjusted based on round-trip time required for the heartbeat request message to be transmitted and its associated heartbeat response message to be returned.

In other implementations, the degree of repetitiveness of communication can be fixed or can be modified based upon a feedback arrangement using parameters supplied by the heartbeat request message and/or the heartbeat response. For instance, requests from the outside device 16 can increase the degree of repetitiveness to quicken response by the inside device 12. When the requests of the outside device 16 have been satisfied by the inside device 12, the degree of repetitiveness can be reset to a lower level until the outside device again has requests to be fulfilled by the inside device. In addition, the inside component of the inside device 12 can be configured to detect a predefined amount of idle time since the last request by the outside device 16 and can subsequently adjust the degree of repetitiveness accordingly. This degree of repetitiveness can be defined as a state variable to regulate the amount of heartbeat request messages being transmitted.

The coupling of the transmission of the heartbeat request message by the inside component and the reply transmission of the heartbeat response message of the outside component is well suited for network environments having NATs and firewalls without the undesired NAT and firewall configurations found with conventional approaches.

When the outside device 16 acknowledges receipt of one of the heartbeat request messages from the inside device 12, the acknowledging heartbeat response message transmitted by the outside device can carry payloads inside the acknowledgement data. The payloads can contain requests, data, executables, commands or other such computer files. This mechanism thus layers bi-directional “peer-to-peer” communication on top of a uni-directional periodic heartbeat mechanism.

The responses by the inside device 12 to requests by the outside device 16 can be sent on the next heartbeat message request to function in a manner like synchronous communication. Alternatively, the responses by the inside device 12 to requests by the outside device 16 can be sent not on the next heartbeat message request, but rather on any subsequent heartbeat message request whenever the inside device has a response ready to function in a manner similar to asynchronous communication.

Requests by the outside device 16 can also take the form of executable code and commands issued remotely that influence system state. Requests by the outside device 16 can also transfer payloads of files to the inside device 12 or can be a series of requests, which can later be run on the inside device in a batch mode when all the inputs to the batch job are ready.

The heartbeat communication can be run over a transport recognized as reliable, such as TCP, that can provide for reliable communication on top of an unreliable medium. The heartbeat communication of the across firewall communication system can be encrypted and secured using conventional protocols such as SSL/TLS or IPSEC. The across firewall communication system reduces or eliminates much complex and expensive conventional re-configuration of deployed NAT and firewall infrastructure and accomplishes the same outcome as much more complex conventional techniques which are not as extensible.

Some implementations of the across firewall communication system use a conventional SOAP/XML protocol encapsulated over SSL/TLS for the heartbeat communication. Requests and responses by the outside device 16 can also use the conventional SOAP/XML protocol.

A variety of different types of the outside devices 16 and the inside devices 12 can be used with the peer to peer heartbeat communication mechanism of the across firewall system. For instance, the outside component can involve wireless broadband controllers or access points and the Operational Support System (OSS). The inside component can be packaged inside a hardware controller, or a Linux appliance or a free-standing piece of software running on any computer, or any compute network equipment within the network.

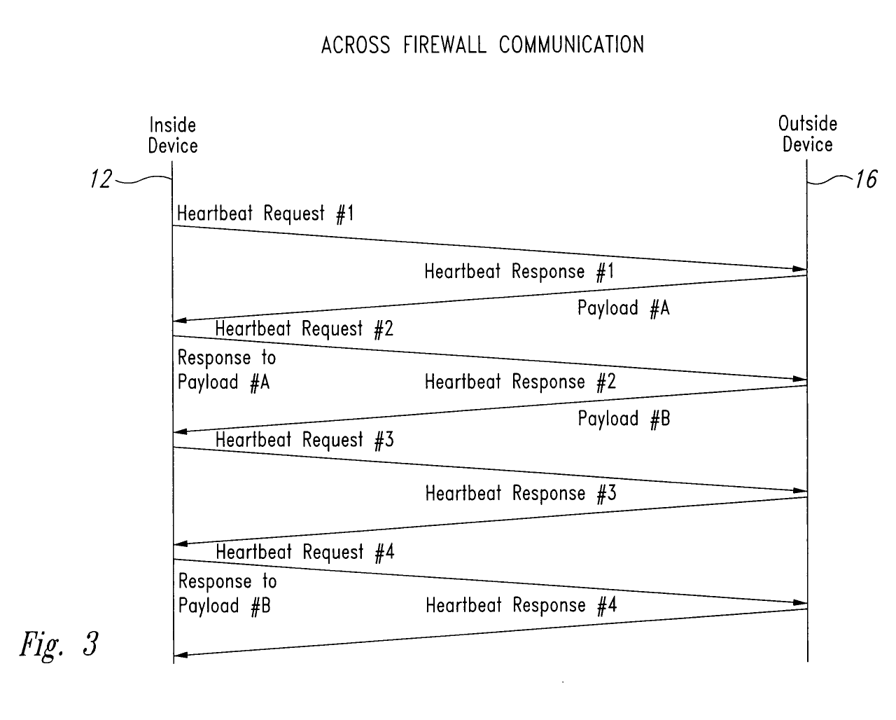

Examples of the across firewall communication system in operation are depicted in the communication diagram of FIG. 3. First depicted is a heartbeat request message #1 sent from the inside component of the inside device 12 to the outside component of the outside device 16. A heartbeat response message #1 is sent in reply to the heartbeat request message #1 back from the outside component of the outside device 16. Included with the heartbeat response message #1 is a payload #A, which may contain requests, data, executables, commands or other such computer files.

A heartbeat request message #2 is sent as the next heartbeat request message subsequent to the heartbeat request message #1 from the inside device 12 to the outside device 16. Along with the heartbeat request message #2, a response to payload #A is also sent from the inside device 12 to the outside device 16 demonstrating synchronous communication qualities described above. A heartbeat response message #2 is sent in reply to the heartbeat request message #2 back from the outside component of the outside device 16. Included with the heartbeat response message #2 is a payload #B, which may contain requests, data, executables, commands or other such computer files.

A heartbeat request message #3 is sent as the next heartbeat request message subsequent to the heartbeat request message #2 from the inside device 12 to the outside device 16. This time no response to payload #B is sent with the heartbeat request message #3 partially demonstrating asynchronous communication qualities described above. A heartbeat response message #3 is sent in reply to the heartbeat request message #3 back from the outside component of the outside device 16.

A heartbeat request message #4 is sent as the next heartbeat request message subsequent to the heartbeat request message #3 from the inside device 12 to the outside device 16. Along with the heartbeat request message #4, a response to payload #B is also sent from the inside device 12 to the outside device 16 further demonstrating asynchronous communication qualities described above. A heartbeat response message #4 is sent in reply to the heartbeat request message #4 back from the outside component of the outside device 16.

As to a further discussion of the manner of usage and operation of the present invention, the same should be apparent from the above description. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Other objects and advantages of the present invention will become obvious to the reader and it is intended that these objects and advantages are within the scope of the present invention.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

The invention claimed is:

1. A method comprising:
selecting a plurality of instances of time;
at each of the plurality of instances of time, sending a heartbeat message from a first computer located on an intranet network through a firewall to a second computer located on an outside system to establish a communication connection between the first computer and the second computer; and
in response to at least one of the heartbeat messages, sending a response message from the second computer to the first computer with the communication connection, the response message containing a payload.

2. The method of claim 1 wherein the communication connection is a peer-to-peer connection.

3. The method of claim 1 wherein the payload contains at least one of the following: data, commands, executables, and an application file.

4. The method of claim 1 wherein the plurality of instances are selected to occur on one of the following: a periodic basis and a non-periodic basis.

5. The method of claim 1 wherein at least one of the response messages acknowledges one of the heartbeat messages sent without containing a payload.

6. The method of claim 1 further including sending a response message from the first computer to the second computer in response to contents of a payload of a response message sent from the second computer to the first computer.

7. A method comprising:
sending on a predetermined interval basis a plurality of heartbeat messages over a period of time from a first computer located on an intranet network through a firewall to a second computer located on an outside system to establish a communication connection between the first computer and the second computer; and
in response to the heartbeat messages, sending a response message from the second computer to the first computer through each of the communication connections established by each of the heartbeat messages.

8. The method of claim 7 wherein the predetermined interval basis includes one of the following: a periodic basis and a non-periodic basis.

9. The method of claim 7 wherein the communication connection is a peer-to-peer connection.

10. The method of claim 7 wherein one of the response messages contains a payload.

11. The method of claim 10 wherein the payload contains at least one of the following: data, commands, executables, and an application file.

12. The method of claim 10 further including sending a response message from the first computer to the second computer through one of the communication connections in response to contents of the payload.

13. A computer media containing instructions to implement the following method:
sending on a predetermined interval basis a plurality of heartbeat messages over a period of time from a first computer located on an intranet network through a firewall to a second computer located on an outside system to establish a communication connection between the first computer and the second computer; and
in response to the heartbeat messages, sending a response message from the second computer to the first computer through each of the communication connections established by each of the heartbeat messages.

14. The method of claim 7 wherein the predetermined interval basis includes one of the following: a periodic basis and a non-periodic basis.

15. The method of claim 7 wherein the communication connection is a peer-to-peer connection.

16. The method of claim 7 wherein one of the response messages contains a payload.

17. The method of claim 10 wherein the payload contains at least one of the following: data, commands, executables, and an application file.

18. The method of claim 10 further including sending a response message from the first computer to the second computer through one of the communication connections in response to contents of the payload.
